(19) United States
(12) Patent Application Publication
(10) Pub. No.: US 2025/0060207 A1
(43) Pub. Date: Feb. 20, 2025

(54) Shape Estimation of Structures Undergoing Dynamic Stress

(71) Applicant: Massachusetts Institute of Technology, Cambridge, MA (US)

(72) Inventors: Tairan Wang, Chelmsford, MA (US); Daniel Freeman, Reading, MA (US); Mihai Ibanescu, Arlington, MA (US)

(73) Assignee: Massachusetts Institute of Technology, Cambridge, MA (US)

(21) Appl. No.: 18/808,320

(22) Filed: Aug. 19, 2024

Related U.S. Application Data
(60) Provisional application No. 63/520,163, filed on Aug. 17, 2023.

(51) Int. Cl. G01B 5/18; G01B 5/213; G01B 11/22

(52) U.S. Cl. CPC G01B 5/18; G01B 5/213; G01B 11/22

(57) ABSTRACT

Described herein are systems and techniques for estimating a shape of a structure undergoing dynamic stress. In some embodiments, a method includes: for each of a plurality of nodes distributed along a length of the structure, obtaining, from an accelerometer located at the node, a tilt angle corresponding to an angle between a local axis of the structure and a direction of gravity; calculating, by a microcontroller, vertical displacements between adjacent pairs of the plurality of nodes using the respective tilt angles obtained for the adjacent pairs; and calculating, by the microcontroller, a depth of each of the plurality of nodes relative to a proximal end of the structure by adding the vertical displacements calculated for adjacent pairs of the plurality of nodes between the node and the proximal end of the structure.

### CROSS-REFERENCE TO RELATED APPLICATIONS

This application claims the benefit under 35 U.S.C. § 119 of U.S. Provisional Patent Application No. 63/520,163 filed on Aug. 17, 2023, which is hereby incorporated by reference herein in its entirety.

### STATEMENT REGARDING FEDERALLY SPONSORED RESEARCH

This invention was made with government support under FA8702-15-D-0001 awarded by the U.S. Air Force, and under W15QKN-16-3-0001 awarded by the U.S. Army ARDEC. The government has certain rights in the invention.

### BACKGROUND

The ocean covers 71% of the earth's surface, but little of what lies beneath the surface has been explored or studied in detail. Important properties of the ocean (temperature, salinity, water color, water clarity, chemical constituents, etc.) are sparsely sampled spatially and temporally, due to limitations in current sensing platform performance, size/weight/power (SWaP) logistics and handling. Current in situ-ocean sensing technology has limited spatial and temporal resolution and is difficult to sustain due to cost.

There are two principal, legacy ocean sensing design patterns. The first is used primarily in defense applications which locate and track acoustic signals (mechanical sound or explosive energy) as they propagate in marine environments. These typically include a network of pressure sensors packaged for rapid deployment across large coverage areas (A-sized containers). The second may be used for environmental science and climate monitoring. These scientific platforms have been primarily all-weather, large, expensive, one-of-a-kind data collectors that operate independently from one another. A typical platform may include an apex, surface buoy housing data processing, communications, and microcontrollers. Below the surface buoy, a relatively small number of sensors/instruments are deployed at depths limited by the cable and ballast controls.

### SUMMARY

More recently, ocean sensing fiber systems have been developed for persistent collection of ocean data. Such systems can provide better understanding and utilization of the undersea environment. In such systems, multifunctional fiber cables (or “fibers”) are used to obtain undersea depth measurements, with each fiber including one or more sensing nodes embedded within the fiber and distribution along its. A given sensing node can include one or more types of sensors (e.g., a hydrophone, temperature sensor, salinity sensor, accelerometer, magnetometer, photodiode, etc.) and associated circuitry.

The fibers can harvest power from the ocean, supply this power to the embedded sensors, and prepare return signals for long-haul communications over satellite links. The fibers (e.g., linear fibers including but not limited to single strand, braided rope/cable, net configurations) can be integrated with a range of platforms, with a given platform including one or more central microcontrollers, data storage, communications infrastructure, intelligent reserve battery power, and possibly other electrical or mechanical components (e.g., an apex, surface buoy housing data processing, etc.). Individual fibers can be formed from a flexible material, such as polymer, providing a flexible and/or deformable sensing structure. Thus, to localize sensor measurements, it is necessary to determine the depth of nodes along an ocean sensing fiber.

Submersible, hydrostatic-pressure sensors have been used to measure depth. State of the art pressure sensors use microelectromechanical system (MEMS) devices to measure pressure difference across a diaphragm. As the saltwater depth increases, the diaphragm deflects based on the density of the liquid and depth in the liquid. While these sensors are accurate, it is challenging to protect the exposed diaphragm from the environment which may lead to damage or failure in the readout electronics. For example, with sensor systems that utilize polymer encapsulation, near the edges of the diaphragm, there can be small gaps between the encapsulant and the diaphragm, which can allow water to slowly penetrate, thereby limiting the overall lifetime of the system. Furthermore, it is common for manufacturers to label them as “intended for use with non-corrosive, non-ionic working fluids such as air, dry gases and the like.” Seawater is an abundant source of ions, is corrosive, and is increasingly acidified. As a result this type of depth sensor is less than ideal for long-endurance missions.

The present disclosure general relates to concepts, systems, and techniques for estimating the shape (e.g., 2D or 3D shape) of a flexible or deformable structure undergoing dynamic stress. The shape estimate is derived from multiple accelerometers, placed along the length of a multifunctional fiber, connected with a microcontroller/power source, and mated with the deformable structure.

One application of the general concepts, systems, and techniques disclosed herein is ocean sensing fiber systems. In this application, the multifunctional fiber is configured to use the accelerometers to provide local, undersea depth measurements for each sensing node along the ocean sensor array. By measuring the tilt of the fiber with respect to gravity at each of the accelerometers, a microcontroller can determine the shape of the array and therefore the depth of each accelerometer including the fiber tip. Combining these depth data points with data from other sensors distributed along the same fiber allows the measurement of a detailed and comprehensive profile of interested metrics in the depth covered by the fiber.

The general concepts, systems, and techniques disclosed herein have been validated in relevant ocean sensing environments. It has been shown that accelerometer-based depth measurement can achieve high level of agreement with conventional pressure sensors (less than 2 cm RMSE). Compared to pressor sensors, accelerometer-based depth measurement offers advantages including, but not limited to, its encapsulated, low drag, and low-adhesion profile which prevents biofouling and enables long mission duration and reuse.

It should be appreciated that ocean sensing is merely one application, and that the general concepts, systems, and techniques disclosed herein may applied for shape estimation in many different technical domains and systems.

According to one aspect of the present disclosure, a method is provided for estimating a shape of a structure undergoing dynamic stress, the method including: for each of a plurality of nodes distributed along a length of the structure, obtaining, from an accelerometer located at the node, a tilt angle corresponding to an angle between a local axis of the structure and a direction of gravity; calculating, by a microcontroller, vertical displacements between adjacent pairs of the plurality of nodes using the respective tilt angles obtained for the adjacent pairs; and calculating, by the microcontroller, a depth of each of the plurality of nodes relative to a proximal end of the structure by adding the vertical displacements calculated for adjacent pairs of the plurality of nodes between the node and the proximal end of the structure.

In some embodiments, calculating the vertical displacements between adjacent pairs of the plurality of nodes includes approximating the shape of the structure between adjacent pairs of nodes as an arc of a circle. In some embodiments, calculating the vertical displacements between adjacent pairs of the plurality of nodes includes approximating the shape of the structure between adjacent pairs of nodes as a straight line. In some embodiments, the structure is flexible and/or deformable. In some embodiments, the structure is a fiber cable. In some embodiments, the accelerometers are evenly spaced along the length of the structure.

In some embodiments, the proximal end of the structure is attached to a platform. In some embodiments, the platform includes at least one of a: a ship; an unmanned underwater vehicle (UUV); an autonomous surface sail drone; a buoy; and a platform drilled into sea ice. In some embodiments, the accelerometers comprise MEMS accelerometers. In some embodiments, the accelerometers comprise 3-axis accelerometers. In some embodiments, the plurality of nodes is connected to the microcontroller via a data bus embedded in the structure.

In some embodiments, the method further includes calibrating one or more of the accelerometers by positioning the structure straight along the direction of gravity at the one or more of the accelerometers and recording acceleration along three axes. In some embodiments, one or more of the plurality of nodes includes at least one sensor other than the respective accelerometer located at the node.

According to another aspect of the present disclosure, a system includes: a microcontroller and a flexible structure having a plurality of nodes distributed along a length of the structure, each of the plurality of nodes communicably coupled to the microcontroller. The microcontroller is configured to: for each of the plurality of nodes, obtain, from an accelerometer located at the node, a tilt angle corresponding to an angle between a local axis of the structure and a direction of gravity; calculate vertical displacements between adjacent pairs of the plurality of nodes using the respective tilt angles obtained for the adjacent pairs; and calculate a depth of each of the plurality of nodes relative to a proximal end of the structure by adding the vertical displacements calculated for adjacent pairs of the plurality of nodes between the node and the proximal end of the structure.

In some embodiments, calculating the vertical displacements between adjacent pairs of the plurality of nodes includes approximating a shape of the structure between adjacent pairs of nodes as an arc of a circle. In some embodiments, calculating the vertical displacements between adjacent pairs of the plurality of nodes includes approximating a shape of the structure between adjacent pairs of nodes as a straight line. In some embodiments, the structure is a fiber cable. In some embodiments, the accelerometers are evenly spaced along the length of the structure. In some embodiments, the proximal end of the structure is attached to a platform. In some embodiments, the plurality of nodes is connected to the microcontroller via a data bus embedded in the structure.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIGS. 1A and 1B are schematic diagrams illustrating a technique for estimating the shape of a flexible or deformable structure undergoing dynamic stress, according to some embodiments.

FIG. 2 is a block diagram illustrating a system for estimating the shape of a flexible or deformable structure undergoing dynamic stress, according to some embodiments.

FIG. 3 is a flow diagram showing an illustrative process for estimating the shape of a flexible or deformable structure undergoing dynamic stress, according to some embodiments.

FIGS. 4A and 4B are plots illustrating the effectiveness of shape estimation using accelerometers compared to using pressure sensors.

The drawings are not necessarily to scale, or inclusive of all elements of a system, emphasis instead generally being placed upon illustrating the concepts, structures, and techniques sought to be protected herein.

### DETAILED DESCRIPTION

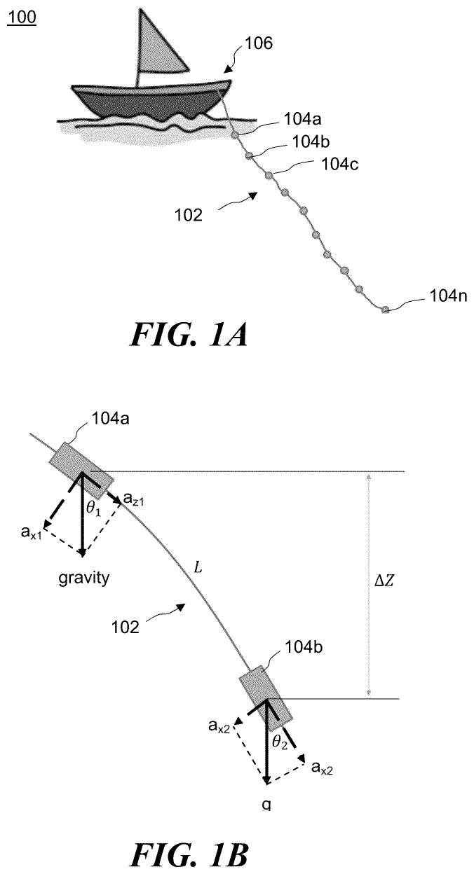

Turning to FIGS. 1A and 1B, embodiments of the present disclosure relate to a technique for estimating the shape (e.g., 2D or 3D shape) of a flexible or deformable structure undergoing dynamic stress. The shape estimate is derived from multiple accelerometers, placed along the length of a multifunctional fiber, connected with a microcontroller/power source, and mated with the deformable structure.

Existing depth measurement tools require a pressure sensor deployed at the depth in question. In underwater use cases, the measured pressure is used to calculate the depth from gravitational constant and density of water. In in-air use cases, the measured pressure is used to calculate height from either a pressure-height lookup table or physics models. In all cases, a pressure sensor is required, which tends to be bulky, especially for underwater use cases. Pressure sensors also must have openings to expose the diaphragm to the surrounding media, increasing integration challenge and reduced long-term reliability due to water ingress and biofouling.

In contrast to pressure sensors, the structures and techniques disclosed herein do not require an exposed diaphragm, but instead uses an accelerometer that can be entirely separated from the water (e.g., it can be fully encapsulated in polymer, or it can be enclosed in a hermetic enclosure). These accelerometers may be provided using MEMS technology where, instead of a diaphragm, a test-mass is suspended in a microscopic cavity. As the sensor experiences acceleration, the test-mass moves closer to one side of the cavity than the other, inducing a change in electrical signal that can be read out, thus enabling measurement of acceleration. In a 3-axis accelerometer, the acceleration in 3D can be measured. Since the accelerometer measures the relative position of the test-mass to the cavity, it cannot differentiate between the effect of gravity from the effect of acceleration. That is to say, 3-axis accelerometer measures gravitational acceleration as if there was an acceleration of the same magnitude and opposite direction.

This property makes it possible to use 3-axis accelerometers to measure the local direction of the gravity, with respect to the axes of the accelerometer. By embedding 3-axis accelerometers into an object, the inclination of the object with respect to local gravity can be measured by computing the angle between the measured acceleration with the calibrated acceleration when the object is in a known inclination to local gravity.

Further, since the measurement does not require any computation using data points from different times, any noise resulting from fluctuation in object's actual acceleration can be filtered out through averaging over time or other advanced techniques.

The relatively small size and low cost of 3-axis accelerometers make them well suited for use in a wide variety of applications, including but not limited to embedding into fiber or cable undersea sensing applications.

Referring to FIG. 1A, an illustrative system 100 includes multiple sensing nodes 104a, 104b, 104c, . . . , 104n (104 generally) placed at known positions along a fiber 102 affixed to a platform 106. Platform 106 may correspond to, for example, a manned ship, an unmanned ship, a manned underwater vehicle, an unmanned underwater vehicle (UUV), a surface sail drone (autonomous or not), a durable surface buoy (drifting or moored), a device drilled into sea ice, or a device tethered to a coral reef. In FIG. 1A, platform 106 is shown as a ship merely for illustrative purposes.

Each sensing node 104 can include an accelerometer along with one or more other sensors, such as a hydrophone, temperature sensor, salinity sensor, accelerometer, magnetometer, photodiode, etc. In some embodiments, the accelerometers may be provided as 3-axis accelerometers.

A given sensing node 104 can be configured to take measurements using its sensors (including but not limited to its accelerometer) and transmit sensor measurement data to a central microcontroller (not shown). In some embodiments, the multiple nodes 104 may be electrically connected to the microcontroller via a data bus that extends along the length of the fiber 102 and terminates near the proximal end of fiber 102, e.g., the end affixed to platform 106. Various approaches can be used to enable the microcontroller to determine which node transmitted particular sensor measurement data. For example, each node can be fabricated to have a unique hardware-based identifier that it transmits with sensor measurement data which allows its data to be recognized (e.g. 6-pins may be provided that are tied to either a supply voltage, VDD, or a reference/ground voltage, GND, providing 26 different identifiers). As another example, this can be done using software, where each node is identical (hardware-wise) and in software it has a unique identifier. In some embodiments, the central microcontroller may be located on the platform 106. In other embodiments, the central microcontroller may be integrated into fiber 102, e.g., at the proximal end of fiber 102. Various other microcontroller placements and connections between the microcontroller and sensing nodes 104 may be used.

The distal end of fiber 102 (e.g., the end where node 104n is located) can be lowered to a depth under gravity. If fiber 102 were to assume a completely vertical straight-down shape, the depth of each sensing node 104 could be simply derived from the known distance between the nodes 104 (e.g., the nodes may be evenly spaced along the length of the fiber). In practice however, as fiber 102 is buffeted by water or air currents, the fiber shape will deviate from vertical.

Turning to FIG. 1B, accelerometers located at each of the sensing nodes 104a, 104b, etc. can measure (e.g., continuously measure) the angle between the local axis of the fiber and direction of gravity, sometimes referred to as the “tilt angle.” For example, the accelerometer at node 104a can measure angle θ₁, the accelerometers at node 104b can measure angle θ₂, etc. The vertical displacement between two adjacent nodes (e.g., nodes 104a and 104b) can be calculated from the tilt angles measured by their respective accelerometers (e.g., θ₁ and θ₂).

In some embodiments, where the sensing nodes are relatively small and the cable cross-section is mostly uniform along its length, then vertical displacement between adjacent nodes can be approximated by assuming the cable shape between two nodes is an arc of a circle. In some embodiments, “relatively small” can be defined as being in the range of 1 to 10 millimeters. In other embodiments, “relatively small” can be defined as being in the range of 1 to 100 millimeters. In this case, the vertical displacement between adjacent nodes can be estimated using a trigonometric expansion such as follows:

$$Δ Z \approx L \frac{sin {θ}_{1} - sin {θ}_{2}}{{θ}_{1} - {θ}_{2}} = L ( 1 - \frac{{θ}_{1}^{2} + {θ}_{2}^{2} + {θ}_{1} {θ}_{2}}{3 !} + \frac{{θ}_{1}^{4} + {θ}_{1}^{3} {θ}_{2} + {θ}_{1}^{2} {θ}_{2}^{2} + {θ}_{1} {θ}_{2}^{3} + {θ}_{2}^{4}}{5 !} + … ) \qquad ( 1 )$$

In other embodiments, where sensing nodes 104 are large compared to the circle, most of the drag force and gravity force will be on the nodes as opposed to the cable length in between. In this case, a good approximation may be to assume the cable shape is a straight line between nodes. the vertical displacement between adjacent nodes can be estimated as:

$$Δ Z \approx L cos ( \frac{{θ}_{1} + {θ}_{2}}{2} ) \qquad ( 2 )$$

In yet other embodiments, a more sophisticated model can be used to capture the exact shape of the curve the fiber can take between sensors. For example, a model can be provided that takes into account the finite mass of the fiber and/or buoyancy from the water, which will make the shape deviate from a circle.

Using accelerometer data obtained from the multiple nodes 104, the microcontroller can compute or otherwise calculate the depth of each sensing node by adding the vertical displacements of all the proximal segments. In other words, the microcontroller can sum over the vertical displacements calculated for all pairs of adjacent nodes between a given node (inclusive of the given node) and the proximal end of the fiber 102 (e.g., the end of the fiber closest to platform 106). For example, to determine the depth of node 104n, the microcontroller can calculate the vertical displacement between nodes 104a and 104b, between nodes 104b and 104c, . . . , between nodes 104n-1 and 104n, and then sum these vertical displacements.

To compute the angle the fiber 102 takes with respect to local gravity, a calibration step can be performed where the fiber 102 is positioned straight along the gravity direction at the sensor to be calibrated, the acceleration along all three axes is recorded: (aₓ₀, a_{y0}, a_{z0}). During measurement, the angle can be computed by finding the angle between the measured acceleration (aₓ, a_{y}, a_{z}) with the calibrated acceleration (aₓ₀, a_{y0}, a_{z0}):

$$θ = arccos ( \frac{{a}_{x 0} \times {a}_{x} + {a}_{y 0} \times {a}_{y} + {a}_{z 0} \times {a}_{z}}{\vert {a}_{0} \vert \times \vert a \vert} ) , \qquad ( 3 )$$

$$where \vert {a}_{0} \vert = \sqrt{{a}_{x 0}^{2} + {a}_{y 0}^{2} + {a}_{z 0}^{2}} , and \vert a \vert = \sqrt{{a}_{x}^{2} + {a}_{y}^{2} + {a}_{z}^{2}} .$$

Thus, in operation, each node can first be calibrated with the fiber hanging vertically and at rest, and the accelerometer will report a measured 3-element vector A1=(aₓ₀, a_{y0}, a_{z0}), which gives the direction of the fiber in the accelerometer's coordinate system; in measurement, the 3-element vector A2=(aₓ, a_{y}, a_{z}) gives the direction of the gravity in the accelerometer's coordinate system, and the angle θ can be derived from

$$cos θ = \frac{A 2 \cdot A 1}{\vert {A}_{1} \vert \cdot \vert {A}_{2} \vert} .$$

This approach is robust against potential issues like alignment of the accelerometer axis with the fiber direction.

In some embodiments, the accelerometers may be provided as MEMS accelerometers, which are small (mm-scale) and compact, minimizing the overall fiber volume and enabling longer-length fibers to fit inside a given deployable-buoy. In some embodiments, MEMS accelerometers can be fully hermetically within the fiber 102 (e.g., polymer fiber) such that they are sealed against the environment, leading to increased robustness, and longer operational life.

In some embodiments, to facilitate measuring depth in multiple points of depth, current probes can be equipped to configure its buoyancy to achieve different depth. The power requirements of the equipment involved limit the operational duration of such a probe due to the limited battery capacity available. A fiber-based system can cover a large extent of depth in one continuous fiber. Without the need to change buoyancy to physically get to different depth, such a system can have much lower power and therefore much longer operational duration. Another advantage of continuous sensing as compared to buoyancy-controlled devices is that the continuous sensing can provide a snapshot of measurements (e.g., temperature) across the water column, whereas the buoyancy-controlled device can drift laterally in the water due to ocean currents, which prevent a measurement across depth at a given location.

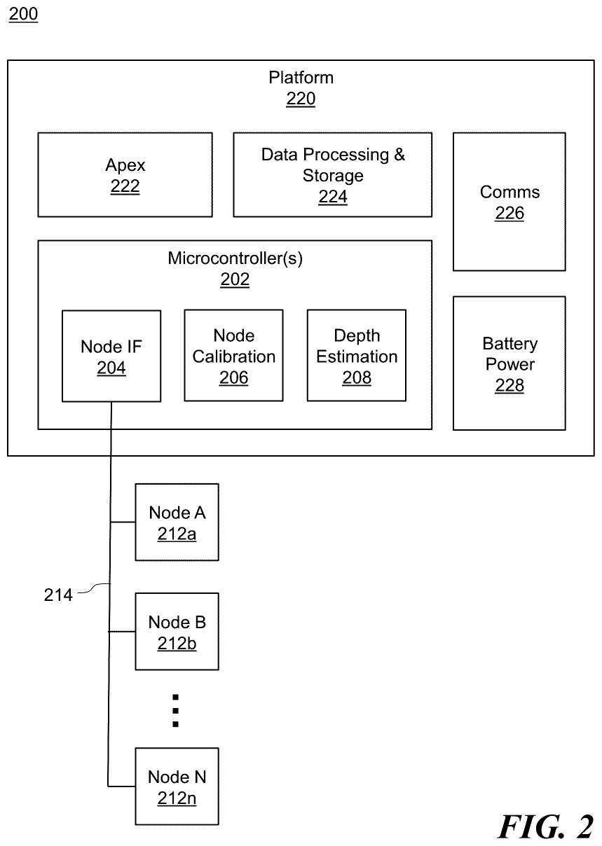

FIG. 2 shows an example of a system for estimating the shape of a flexible or deformable structure undergoing dynamic stress, according to some embodiments. Illustrative system 200 includes a microcontroller 202 having a node interface 204, a node calibration processor 206, and a depth estimation processor 208. A plurality of sensing nodes 212a, 212b, . . . , 212n (212 generally) can be communicably coupled to microcontroller 202 via a data bus 214 and node interface 204. Microcontroller 202 can include, for example, one or more processor cores, memory, and programmable input/output (IO). In some cases, microcontroller 202 may be provided as two or more microcontrollers 202, each configured to perform one or more of the processing techniques disclosed herein.

Sensing nodes 212 of FIG. 2 may be the same as or similar to sensing nodes 104 of FIGS. 1A and 1B. Data bus 214 and sensing nodes 212 can be encapsulated with a fiber cable, as previously discussed. Microcontroller 202 can be located upon a platform 220 further comprising an apex 222, data processing and storage 224 (e.g., surface buoy housing data processing), communications infrastructure 226, and a battery power system 228 (e.g., an intelligent reserve battery power system) for example. In some cases, communications infrastructure 226 can be used to sensor data off of the platform 220 transmit (e.g., wirelessly via a satellite uplink) to a ground-based operations center, or example.

Node calibration processor 206 can be configured to perform a calibration step for each of the sensing nodes 212a in which the fiber is positioned straight along the gravity direction at the sensing node to be calibrated and obtaining acceleration data along all three axes: (aₓ₀, a_{y0}, a_{z0}). This data can be obtained from the node's accelerometers via data bus 214 and node interface 204, for example. In some embodiments, node calibration processor 206 may record the per-node calibration data (e.g., to a volatile or non-volatile memory, such as a memory provided by the platform's data processing and storage 224).

Depth estimation processor 208 can be configured to estimate the depth (or, in the case of air, height) of individual nodes 212 using the techniques described above in the context of FIG. 1B. For example, using calibration data recorded by node calibration processor 206, depth estimation processor 208 can estimate the depth of individual nodes 212 using equation (1) or (2) in combination with equation (3). The depth estimates can be combined with sensor data (e.g., data about temperature, salinity, water color, water clarity, chemical constituents, etc. obtained by individual nodes). The combined data can be processed and/or stored by the platform 220 and/or transmitted to a ground-based operations center.

There are many ways to design the interface electronics that communicates with the node sensors. In the case of a digital sensor, the sensor data can be communicated directly between the sensor and microcontroller via the data bus 214. In the case of an analog sensor, an analog-to-digital converter may be provided either within individual nodes 212 or within the microcontroller 202 to convert analog data to digital data. The electronics for transmitting and receiving sensor data along the data bus 214 can take many forms. For example, each node can include an ASIC that implements a frequency-shift keying (FSK) protocol for transmitting data over the data bus 214. As another example, each node can include a microcontroller that implements I2C digital communication, i.e., a two-wire serial communication protocol using a serial data line (SDA) and a serial clock line (SCL). As another example, FPGA-based transceivers may be provided within nodes 212, and within node interface 204 of microcontroller 202 to communicate sensor data. These are non-limiting examples of interface electronics that can be used with the general concepts and structures sought to be protected herein. In general, interface electronics can be implemented within individual nodes 212, within data bus 214, and/or within node interface 204 of microcontroller 202.

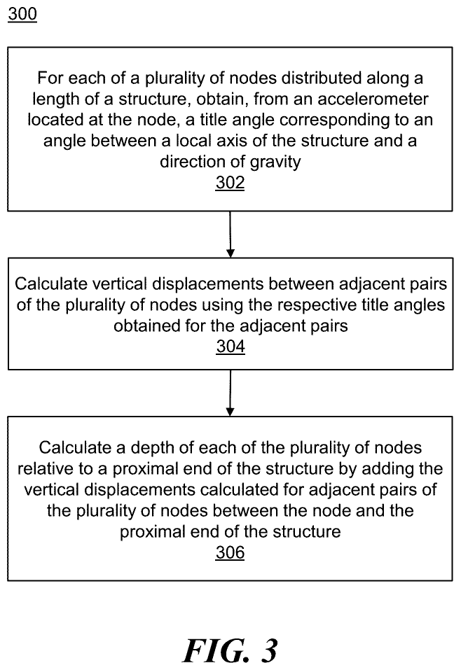

FIG. 3 shows an example of a process 300 for estimating the shape of a structure undergoing dynamic stress. Process 300 can be implemented within and/or executed by a microcontroller (e.g., microcontroller 202 of FIG. 2).

At block 302, for each of a plurality of nodes distributed along a length of the structure (e.g., evenly spaced along the length), a tilt angle can be obtained from an accelerometer located at the node, the tilt angle corresponding to an angle between a local axis of the structure and a direction of gravity.

At block 304, vertical displacements can be calculated between adjacent pairs of the plurality of nodes using the respective tilt angles obtained for the adjacent pairs. In some embodiments, the vertical displacements can be calculated by approximating the shape of the structure between adjacent pairs of nodes as an arc of a circle. In some embodiments, the vertical displacements can be calculated by approximating the shape of the structure between adjacent pairs of nodes as a straight line. In some embodiments, equation (1) or (2) alone or in combination with equation (3) may be used to calculate the vertical displacements.

At block 306, a depth of each of the plurality of sensing nodes can be calculated relative to a proximal end of the structure by adding the vertical displacements calculated for adjacent pairs of the plurality of nodes between the node and the proximal end of the structure.

In some embodiments, the structure may be flexible and/or deformable. In some embodiments, the structure may be a fiber cable. In some embodiments, the structure may be attached to a platform, such as a ship, an unmanned underwater vehicle (UUV), an autonomous surface sail drone, a buoy, a platform drilled into sea ice, etc. In some embodiments, the accelerometers comprise MEMS accelerometers. In some embodiments, the accelerometers comprise 3-axis accelerometers. In some embodiments, the accelerometers can be connected to the microcontroller via a data bus embedded in the structure. In some embodiments, the process can also include a calibration step such as described above in the context of FIG. 1B and equation (3).

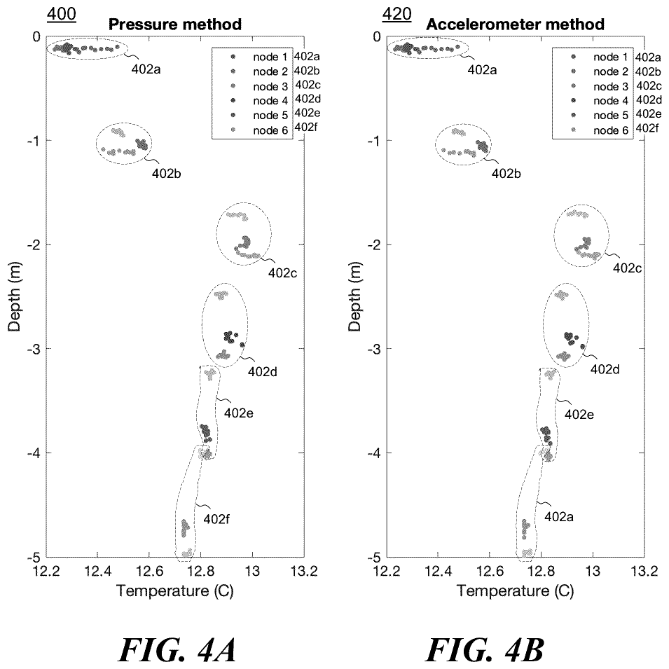

FIGS. 4A and 4B compare depth estimation using pressure sensors (plot 400 of FIG. 4A) and the accelerometers (plot 420 of FIG. 4B). Temperature measurements (x axis) obtained from six sensing nodes 402a-f are plotted against depth (y axis). In plot 400, depth is determined using pressure sensors and temperature is measured using temperature sensors collocated with the pressure sensors. In plot 420, depth is estimated based on accelerometer angle measurements using the techniques disclosed herein, and temperature is measured using temperature sensors collocated with the accelerometers. As shown, depth estimation using the disclosed accelerometer-based technique agrees strongly with the pressure sensor-based depth estimation.

As used herein, the terms “processor,” “controller,” and “microcontroller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can include internal processors or modules that perform portions of the function, operation, or sequence of operations. Similarly, a module can include internal processors or internal modules that perform portions of the function, operation, or sequence of operations of the module.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method for estimating a shape of a structure undergoing dynamic stress, the method comprising:
for each of a plurality of nodes distributed along a length of the structure, obtaining, from an accelerometer located at the node, a tilt angle corresponding to an angle between a local axis of the structure and a direction of gravity;
calculating, by a microcontroller, vertical displacements between adjacent pairs of the plurality of nodes using the respective tilt angles obtained for the adjacent pairs; and
calculating, by the microcontroller, a depth of each of the plurality of nodes relative to a proximal end of the structure by adding the vertical displacements calculated for adjacent pairs of the plurality of nodes between the node and the proximal end of the structure.

2. The method of claim 1 wherein calculating the vertical displacements between adjacent pairs of the plurality of nodes includes approximating the shape of the structure between adjacent pairs of nodes as an arc of a circle.

3. The method of claim 1 wherein calculating the vertical displacements between adjacent pairs of the plurality of nodes includes approximating the shape of the structure between adjacent pairs of nodes as a straight line.

4. The method of claim 1 wherein the structure is flexible and/or deformable.

5. The method of claim 4 wherein the structure is a fiber cable.

6. The method of claim 1 wherein the accelerometers are evenly spaced along the length of the structure.

7. The method of claim 1 wherein the proximal end of the structure is attached to a platform.

8. The method of claim 7 wherein the platform includes at least one of a:
a ship;
an unmanned underwater vehicle (UUV);
an autonomous surface sail drone;
a buoy; and
a platform drilled into sea ice.

9. The method of claim 1 wherein the accelerometers comprise MEMS accelerometers.

10. The method of claim 1 wherein the accelerometers comprise 3-axis accelerometers.

11. The method of claim 1 wherein the plurality of nodes is connected to the microcontroller via a data bus embedded in the structure.

12. The method of claim 1 further comprising calibrating one or more of the accelerometers by positioning the structure straight along the direction of gravity at the one or more of the accelerometers and recording acceleration along three axes.

13. The method of claim 1 wherein one or more of the plurality of nodes includes at least one sensor other than the respective accelerometer located at the node.

14. A system comprising:
a microcontroller;
a flexible structure having a plurality of nodes distributed along a length of the structure, each of the plurality of nodes communicably coupled to the microcontroller,
wherein the microcontroller is configured to:
for each of the plurality of nodes, obtain, from an accelerometer located at the node, a tilt angle corresponding to an angle between a local axis of the structure and a direction of gravity;
calculate vertical displacements between adjacent pairs of the plurality of nodes using the respective tilt angles obtained for the adjacent pairs; and
calculate a depth of each of the plurality of nodes relative to a proximal end of the structure by adding the vertical displacements calculated for adjacent pairs of the plurality of nodes between the node and the proximal end of the structure.

15. The system of claim 14 wherein calculating the vertical displacements between adjacent pairs of the plurality of nodes includes approximating a shape of the structure between adjacent pairs of nodes as an arc of a circle.

16. The system of claim 14 wherein calculating the vertical displacements between adjacent pairs of the plurality of nodes includes approximating a shape of the structure between adjacent pairs of nodes as a straight line.

17. The system of claim 14 wherein the structure is a fiber cable.

18. The system of claim 14 wherein the accelerometers are evenly spaced along the length of the structure.

19. The system of claim 14 wherein the proximal end of the structure is attached to a platform.

20. The system of claim 14 wherein the plurality of nodes is connected to the microcontroller via a data bus embedded in the structure.
